(19) United States
(12) Patent Application Publication
(10) Pub. No.: US 2023/0331535 A1
(43) Pub. Date: Oct. 19, 2023

(54) Pressurized Beverage Dispenser

(71) Applicant: Adrian Rivera, Whittier, CA (US)

(72) Inventor: Adrian Rivera, Whittier, CA (US)

(21) Appl. No.: 17/899,605

(22) Filed: Aug. 30, 2022

Related U.S. Application Data
(60) Provisional application No. 63/242,730, filed on Sep. 10, 2021.

(51) Int. Cl. B67D 1/08; B67D 1/14

(52) U.S. Cl. CPC B67D 1/0835; B67D 1/1405; B67D 2001/0822

(57) ABSTRACT

A tapper assembly for a beverage dispenser includes a container cap, a tap body, and a tap valve. The container cap includes a container interface, a canister interface, and a tap opening. The canister interface is arranged in fluid communication with the container interface and couples with a gas canister. The tap opening couples with the tap body assembly. The tap body includes a tube nozzle, a valve interface, and a faucet. The tube nozzle couples with a tube that extends from the container interface. The valve interface couples the tap body with the tap valve. The faucet provides fluid communication between the tube nozzle and the valve interface. The tap valve includes a tap nozzle and a tap valve body. The tap nozzle dispenses a beverage from the tap valve assembly. The tap valve body couples with the tap body and provides selective fluid communication at the tap nozzle.

### CROSS-REFERENCE TO RELATED APPLICATION

This is related to, and claims priority from, U.S. Provisional Application for Patent No. 63/242,730, which was filed on Sep. 10, 2022, the disclosure of which is incorporated herein in its entirety.

### FIELD OF THE INVENTION

The invention relates to beverage preparation and dispensing and in particular to apparatus for dispensing a brewed beverage such as coffee under pressure of an infused gas such as nitrogen.

### BACKGROUND OF THE INVENTION

Several types of beverages, such as coffee, tea, and herbal drinks, are brewed by infusing or steeping ground or shredded brewing material in water or other liquid. For quick brewing, hot water is typically used. However, cold brewing, that is, infusion of the brewing material in cold or room-temperature water rather than in hot water, is sometimes preferred. For example, some coffee drinkers prefer the flavor provided by cold brewing, and bitterness and acidity can be avoided when brewing certain teas by steeping in unheated water rather than hot water. Such cold brewing is accomplished by submerging a portion of brewing material in unheated water for a period of time to allow the brewing material to infuse the water. The portion of brewing material chosen to make the cold-brew beverage can be adjusted to taste to produce a ready-to-drink beverage, or can be selected to result in a concentrated brew that can be diluted before consuming.

Once prepared and sufficiently steeped, the beverage can be consumed immediately or stored for later consumption. Beverages brewed with hot water are generally consumed soon after brewing, or later if kept warm in the meantime. A cold-brewed beverage can be served as-is, at room temperature, can be poured over ice, or can be heated, to provide a warm drink having cold-brewed taste. If a large quantity of beverage is brewed, it can be stored in a large dispensing container. Preferably, the container is sealed so as not to let oxygen or contaminants in, keeping the beverage fresh. If the sealed container includes a valve at its only access port, the beverage can be served from the container using a pressure system, such as one that uses gas under pressure to dispense the beverage from the container, typically called a keg or tap system.

Typically, such a system stores the beverage in a container having a valved opening at the top, with a flow tube extending inside the container from the opening to near the bottom of the container. Gas pressure applied to the top surface of the beverage inside the container forces the beverage up through the flow tube and out of the opening. A coupler is typically fitted to the opening in engagement with the valve. The coupler receives the gas under pressure from a canister through a conduit and provides it to the interior of the container through the valve. As the pressure from the gas pushes the beverage up the flow tube toward the opening, the coupler diverts the expelled beverage to an outflow tube. This outflow tube is connected at the other end to a dispensing assembly, which has another valve that is selectively opened and closed by a handle. When the handle opens the dispensing valve, beverage flows from the dispensing assembly into a mug or cup. When the handle closes the dispensing valve, flow stops but the pressure from the gas keeps the beverage ready for dispensing at the handle.

This type of setup is convenient for serving a beverage such as beer, for example in a restaurant or bar, in which CO₂ is typically used as the pressurizing gas. Some homes have a similar keg setup for dispensing beer on a smaller scale than a restaurant, usually in a dedicated bar area or patio. However, such an arrangement is not practical for use in serving a beverage such as coffee, particularly at home. Coffee is usually served at home in a kitchen or dining area, where floor space and counter space are typically in short supply and a keg setup would be out of place. A coffee system having a beverage container, pressurized gas canister, tap handle, and tubing would take up much valuable space.

Further, such systems are set up to use canisters of CO₂, which are readily available but are not suitable for use with some brewed beverages, such as coffee. For example, CO₂ gas makes carbonic acid and large, harsh bubbles that are not compatible with coffee in that they can adversely affect the taste and mouthfeel of the coffee. Using pressurized nitrogen gas to push the beverage out of the container, on the other hand, infuses the coffee with smaller, more stable bubbles that impart a complementary flavor and smoother mouthfeel to the coffee.

In addition, these pressurized systems are provided to consumers with the beverage already contained in the container. Certain beverages are available from a retailer or distributor, and a consumer can only choose a beverage from the available selection. The beverage is then provided under pressure in a valved container that can only be dispensed using a compatible tap system. Drinkers of certain beverages, such as coffee, often prefer to brew their own beverages, and are particular about the brand, blend, and brewing method, among other factors. For such consumers, it would be beneficial for a system for use at home to be fillable with a brewed beverage of choice, whether purchased as brewed or brewed by the consumer. Therefore, a system that uses a consumer-fillable, preferably reusable and conveniently un-valved container, would be an improvement over conventional systems.

It would therefore be advantageous to provide a pressurized coffee-serving system that utilizes pressurized nitrogen to dispense and infuse the coffee. It would also be beneficial if such a system could be compact so as to take up little counter space and simple to implement, so as to make the system convenient for personal home use. Such a system would be suitable for use in storing and dispensing other beverages as well.

### BRIEF DESCRIPTION OF THE INVENTION

According to an aspect of the invention, a tapper assembly for a beverage dispenser includes a container cap assembly, a tap body assembly, and a tap valve assembly. The container cap assembly includes an open container interface, a canister interface, and a tap opening. The open container interface is configured to couple with a container opening. The canister interface is arranged in fluid communication with the open container interface and is configured to couple with a gas canister and to receive pressured gas from the gas canister. The tap opening is configured to couple with the tap body assembly. The tap body assembly includes a tube nozzle, a valve interface, and a faucet. The tube nozzle is configured to couple with a tube to extend the tube from the open container interface when the tap body assembly is coupled with the tap opening of the container cap assembly. The valve interface is configured to couple the tap body assembly with the tap valve assembly. The faucet is configured to provide fluid communication between the tube nozzle and the valve interface. The tap valve assembly includes a tap nozzle, and a tap valve body. The tap nozzle is configured to dispense a beverage from the tap valve assembly. The tap valve body is configured to couple with the tap body assembly at the valve interface and to provide selective fluid communication between the valve interface and the tap nozzle.

The canister interface can be configured to couple directly to the gas canister, or configured to couple with the gas canister via a hose.

The tapper assembly can also include a gas canister sleeve configured to receive and hold the gas canister, in which case the canister interface can be configured to couple with the gas canister sleeve. The tapper assembly can also include the gas canister, configured to couple with the canister interface. The gas canister can contain, for example, compressed nitrogen.

The open container interface can include a container coupler configured to couple with the container opening.

The canister interface can include a canister coupler configured to couple with the gas canister.

The tap opening and/or the valve interface can include a tap coupler configured to couple the tap body assembly with the tap valve assembly.

The tapper assembly can also include the tube, coupled with the tube nozzle.

According to another aspect of the invention, a beverage dispenser includes the tapper assembly of the invention, and a container, configured to receive and hold a liquid and including the container opening.

The container interface and/or the container opening can include a container coupler configured to couple the container interface with the container opening.

The container opening can be configured to receive the tube when the tube nozzle is coupled with the tube and the tap body assembly is coupled with the tap opening of the container cap assembly.

Preferably, the container opening is unobstructed. The container can be configured to receive a liquid poured directly into the container opening.

The liquid can be, for example, a brewed beverage, such as coffee.

### BRIEF DESCRIPTION OF THE DRAWINGS

FIG. 1 shows an exemplary brewed beverage dispenser according to the invention.

FIGS. 2A-C show an exemplary container according to the invention.

FIG. 3 shows an exemplary tapper assembly according to the invention.

FIGS. 4A-C show an exemplary container cap assembly according to the invention.

FIG. 5 shows an exemplary gas canister sleeve according to the invention.

FIGS. 6A and B show an exemplary tap valve assembly according to the invention.

FIGS. 7A-C show an exemplary tap body assembly according to the invention.

FIG. 8 shows an exemplary tap body assembly coupled to a tap valve assembly and a container cap assembly according to the invention.

FIG. 9 shows an exemplary handle assembly according to the invention.

FIG. 10 shows an exemplary tube according to the invention.

Corresponding reference characters indicate corresponding components throughout the drawings.

### DETAILED DESCRIPTION OF THE INVENTION

The invention is a tapper assembly configured for use with a beverage dispenser, and includes a container cap assembly, a tap body assembly, and a tap valve assembly. These components are configured and arranged to allow pressurized gas to be used to selectively dispense a beverage from inside an easily refillable container.

The container cap assembly includes an open container interface, a canister interface, and a tap opening. The open container interface is configured to couple with a container opening, to provide fluid communication between the container and the tapper assembly. The canister interface is arranged in fluid communication with the open container interface and is configured to couple with a gas canister and to receive pressured gas from the gas canister. Thus, pressurized gas from a gas canister coupled to the canister interface can flow from the canister to the inside of the container through the container interface. The tap opening is configured to couple with the tap body assembly, which allows the beverage to flow out of the container under pressure of the gas, to be dispensed by the tap valve assembly.

The tap body assembly couples to the container cap assembly at the tap opening to allow uptake of the beverage from the container through a tube. The tap body assembly includes a tube nozzle, a valve interface, and a faucet. The tube nozzle is configured to couple with the tube to extend the tube from the open container interface when the tap body assembly is coupled with the tap opening of the container cap assembly. Thus coupled, the tube will extend into the container through the container interface to provide a conduit for outflow of the beverage when pressurized gas is forced into the container through the container interface outside of the tube.

The valve interface is configured to couple the tap body assembly with the tap valve assembly, which will control dispensing of the beverage. The faucet is configured to provide fluid communication between the tube nozzle and the valve interface so that the beverage that flows into the tap body assembly through the tube nozzle can flow to the tap valve assembly for dispensing.

The tap valve assembly receives the beverage from the tap body assembly through the valve interface, and includes a tap nozzle and a tap valve body. The tap nozzle is configured to dispense the beverage from the tap valve assembly, for example, into a cup or mug. The tap valve body is configured to couple with the tap body assembly at the valve interface and to provide selective fluid communication between the valve interface and the tap nozzle. That is, the valve body includes a valve that allows the flow of beverage to the tap nozzle when open, and prevents the flow of beverage to the tap nozzle when closed.

A handle is provided to control operation of the tap valve body to open and close the valve by the operator of the tapper assembly. Although a physical handle is shown, any type of mechanism for opening and closing the valve can be provided and used, such as a rotary knob, an electronic switch, or any other type of opening and closing mechanism. Likewise, the valve can be any type of mechanical or electronic valve that can allow or prevent the flow of beverage, either from full flow to full stop, or incrementally so as to control the flow rate.

Thus, the container cap assembly covers the container opening and provides a fluid path for the pressurized gas into the container. The tap body assembly provides a nozzle through which the beverage under pressure can flow out of the container via a tube that also passes through the container opening, and a conduit through which the beverage can flow for dispensing. The tap valve assembly receives the beverage from the tap body assembly, and provides a mechanism by which an operator can selectively dispense the beverage into a vessel.

The pressurized gas is provided by a gas canister. The canister interface of the container cap assembly is configured to couple to the gas canister, either directly via a hose or other conduit. To facilitate this arrangement, the tapper assembly can also include a gas canister sleeve configured to receive and hold the gas canister in place during use, in which case the canister interface can be configured to couple with the gas canister sleeve. Certain embodiments of the tapper assembly of the invention can also include the gas canister. The gas canister can contain any type of compressed gas such as, for example, compressed nitrogen. The canister interface can include a valve that can be controlled to allow or prevent flow of the pressurized gas from the canister. Alternatively, the canister can provide such a valve, or the canister can be automatically opened when coupled to the canister interface, such as by puncturing a membrane at the interface.

All the various interfaces and openings coupling elements of the tapper assembly can include coupling elements for mutual mating. For example, the open container interface can include a container coupler configured to couple with the container opening, the canister interface can include a canister coupler configured to couple with the gas canister, and the tap opening and/or the valve interface can include a tap coupler configured to couple the tap body assembly with the tap valve assembly. These couplers can be of any type, utilizing press-fit, friction-fit, threaded, and/or sleeved components, or any other type of coupling components, preferably for providing easy and quick coupling and release.

As mentioned, the tapper assembly couples with a tube, through which the beverage flows under pressure. This tube can be rigid or flexible, such as a hose, and can be fabricated from any suitable material, taking any dimensions suitable for providing reliable flow from the container. Certain embodiments of the tapper assembly can also include the tube, removably or fixedly coupled with or attached to the tube nozzle.

Certain embodiments of the invention can be a beverage dispenser that includes the tapper assembly of the invention, as well as the container, configured to receive and hold the beverage and including the container opening. The container interface and/or the container opening can include a container coupler configured to couple the container interface with the container opening. The container opening can be configured to receive the tube when the tube nozzle is coupled with the tube and the tap body assembly is coupled with the tap opening of the container cap assembly, providing a passage for the tube. Pressure in the container opening is directed into the container except in the tube, in which pressure is directed out of the container. Preferably therefore, the container opening is unobstructed, although the opening can have any suitable profile that enhances or at least allows gas and beverage flow. In any case, the container is preferably configured to receive a liquid poured directly into the container opening. Thus, a user can pour a beverage such as coffee into the container directly through the container opening. The tapper assembly, with the tube in place, can then be coupled to the container at the container interface of the container cap assembly. Once the pressurized gas is allowed to flow at the canister interface, the beverage is ready to be dispensed when the handle opens the valve of the tap valve assembly.

The liquid can be, for example, a brewed beverage, such as coffee.

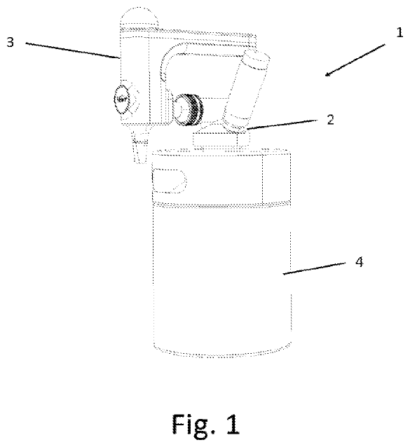

An exemplary embodiment of the invention is shown and described. As shown in FIG. 1, an exemplary brewed beverage dispenser 1 includes a tapper assembly 2 and a handle assembly 3, configured to dispense a beverage from a container 4. In certain embodiments, the dispenser 1 can also include the container 4.

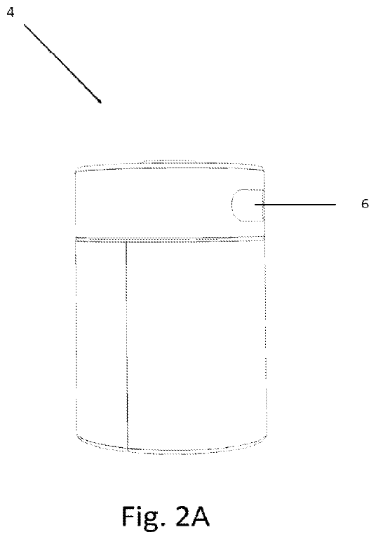

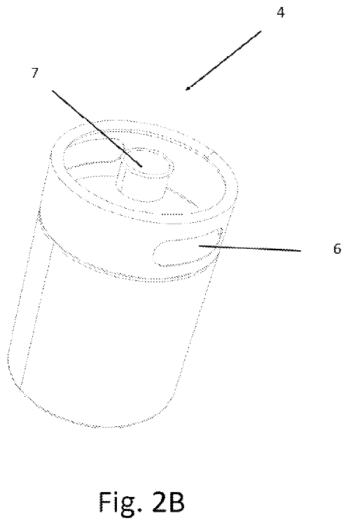

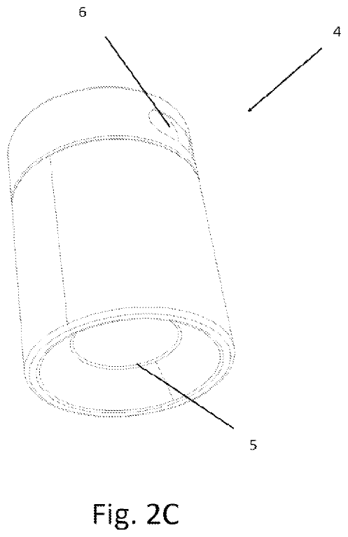

Referring to FIGS. 2A-C, the container 4 is configured to receive and hold the brewed beverage to be dispensed, and can be sized to hold any volume of beverage. For example, for countertop dispensing of coffee or other brewed beverage, a container configured to hold two liters of beverage would be convenient, although other sizes are contemplated for use with the dispenser of the invention. The container 4 as shown is generally cylindrical, with a round cross-section and a planar bottom periphery that provides stability when placed on a surface, the bottom preferably having a recess or punt 5. However, the container 4 can take other shapes without departing from the scope of the invention. For example, the container 4 can have a square cross-section, or at least one squared-off corner, to allow for placement of the container 4 on the corner of a counter and against a corner of a wall, making maximum use of otherwise unused counter space.

Preferably, the container 4 is constructed such that the weight distribution contributes to the stability of the brewed beverage dispenser 1 when in use. For example, when the tapper assembly 2 and a handle assembly 3 are coupled to the container 4 for use, the brewed beverage dispenser 1 could become top-heavy as the amount of beverage in the container 4 is dispensed and depleted. To maintain stability, the container can be bottom-weighted through the distribution of material forming the container to keep the overall center of gravity of the brewed beverage dispenser 1 more toward the bottom of the container. Preferably, the weight distribution allows for one-handed operation of the handle assembly 3, that is, without using another hand to hold the container steady, even when the container is almost empty of beverage.

A top portion of the container 4 can extend upward from the top portion of the main body of the container 4, and can include one or more handles 6 by which the container 4 can be carried. The container 4 includes an opening 7 by which the container 4 can be filled with brewed beverage and through which the beverage is dispensed from the container 4. Pressurized gas can be admitted to the interior of the container 4 through the opening and liquid can flow out of the container 4 under the pressure of the gas through an interior tube extending through the opening 7 and into the container 4.

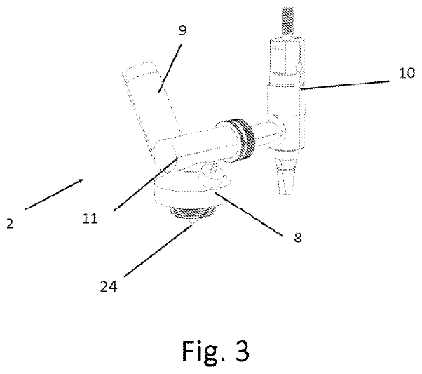

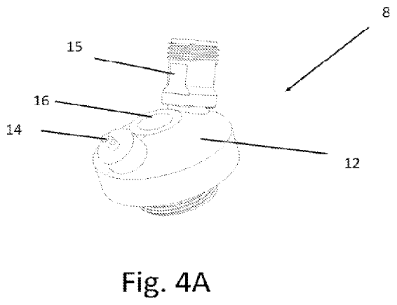

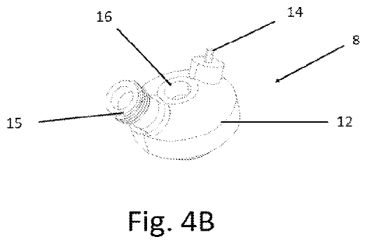

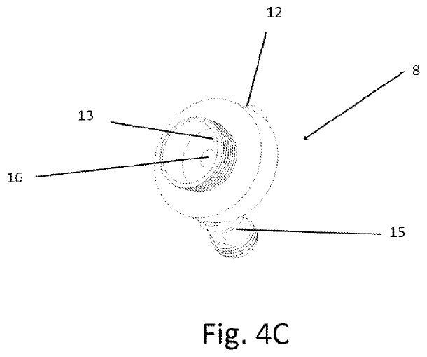

Referring to FIG. 3, the tapper assembly 2 includes a container cap assembly 8, an optional gas canister sleeve 9, a tap valve assembly 10, and a tap body assembly 11. Referring to FIGS. 4A-C, the container cap assembly 8 includes a cap body 12 that couples with the container opening 7, sealing off the opening 7 when in use. The cap body 12 preferably has a relief outlet 13 in which a relief valve 14 is arranged. The relief valve 14 is configured to allow gas to be released from the container 4 through the relief outlet 13 when a maximum pressure threshold is reached in the container, and to release any pressurized gas left in the container 4 after the beverage has been completely dispensed. The cap body 12 also includes a canister coupler 15, configured to couple with the gas canister sleeve 9, and a tap opening 16, configured to receive the tap body assembly 11.

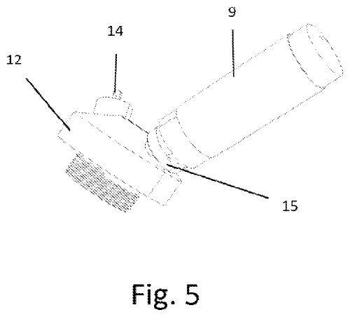

Referring to FIG. 5, the gas canister sleeve 9 is configured to receive a canister of pressurized gas, such as nitrogen gas, and is configured to couple with the canister coupler 15 to enclose the gas canister. When fully seated in place, a valve or membrane in the gas canister opens and allows pressurized gas to flow into the container 4 via the tap opening 16 and the container opening 7 to provide the pressure required to dispense the beverage. For example, the gas canister can be placed in the gas canister sleeve 9, which is then in turn aligned with the opening of the canister coupler 15 such that a valve or membrane of the gas canister is aligned with a protrusion or other element in the canister coupler 15. The gas canister sleeve 9 is then fully coupled, such as by screwing it down against the canister coupler 15 or pressing it down and twisting to lock it in place. Once the gas canister sleeve 9 is fully coupled, the gas canister valve is opened and pressurized gas can flow from the gas canister into the container 4.

In some embodiments, the beverage dispenser of the invention can also include a compact canister of pressurized gas configured to fit in the gas canister sleeve 9 and preferably holding enough pressurized gas to dispense a full container of the beverage. Different sized containers can be made available for use with or as part of the dispensing apparatus, along with respective associated gas canisters that provide the amount of gas needed to dispense that volume of beverage. Alternatively, a larger gas canister can be coupled via a hose or other conduit to the canister coupler 15, with or without the use of the gas canister sleeve 9.

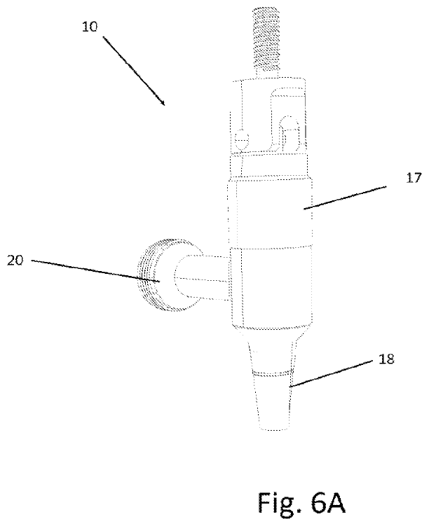

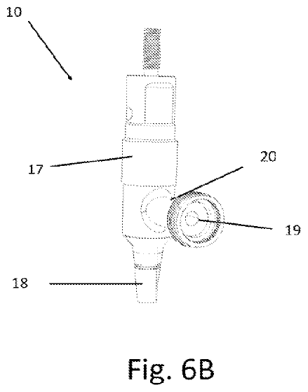

Referring to FIGS. 6A and B, the tap valve assembly 10 includes a tap valve body 17 that is configured to couple with the container cap assembly 8 at the tap opening 16 to receive a flow of beverage from inside the container 4. The tap valve assembly 10 also includes a tap nozzle 18 that couples to the tap valve body 17 to direct the flow of beverage to a drinking or serving container, and is preferably easily removable from the tap valve body 17 for cleaning or replacement. For example, the tap nozzle 18 can be coupled to the tap valve body 17 using threaded coupling or a snap-fit coupler. One or more diffusers can be arranged in the tap nozzle 18 or at the coupling connection between the tap valve body 17 and the tap nozzle 18 to affect the nature of the flow of beverage from the tap nozzle 18. The beverage flows into the tap valve body 17 via a passage 19 in a tap valve coupler 20 in the tap valve body 17.

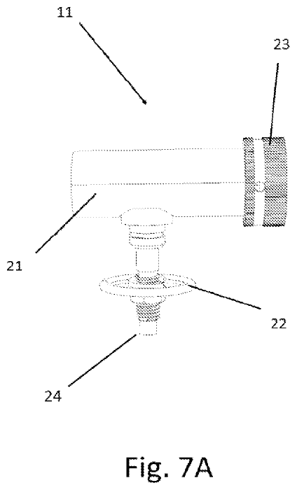

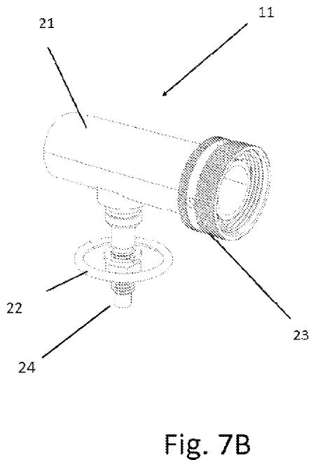

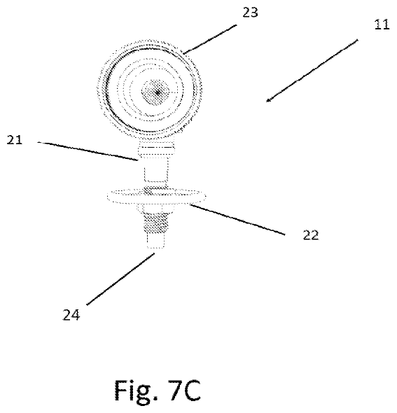

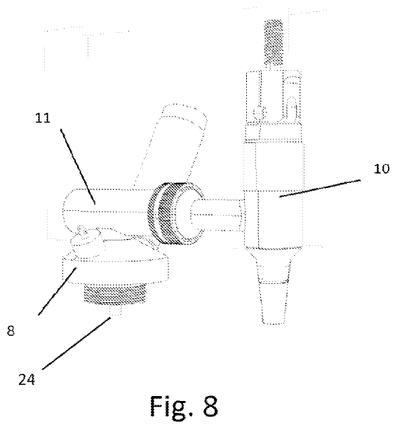

Preferably, the tap valve assembly 10 couples with the container cap assembly 8 by way of the tap body assembly 11. Referring to FIGS. 7A-C, the tap body assembly 11 includes a faucet 21 conduit and a tube nozzle 24 or other hollow probe-type interface configured to enter and couple with the tube 25, allowing the beverage to flow through the hollow interior of the faucet 21 to the tap valve assembly 10. Preferable, a seal, such as a resilient O-ring 22, is arranged to seal the interface between the faucet and the container cap assembly 8. A coupler 23 such as a captive screw-on ring is provided to mate the other end of the tap valve assembly to the faucet 21. FIG. 8 shows the tap body assembly 11 coupled to the tap valve assembly and the container cap assembly 8.

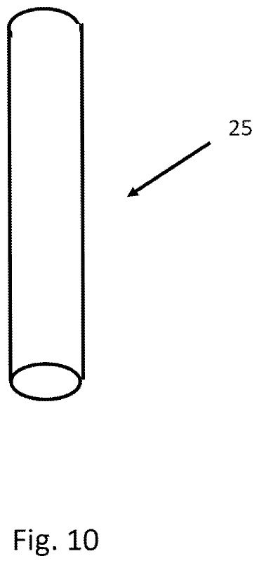

The tap body assembly 11 includes a tube nozzle 24 at one end of the faucet 21, which enters the opening 7 of the container 4 when the container cap assembly 8 is coupled to the container 4 at the opening 7. Referring to FIG. 10, a tube 25, such as a plastic or metal tube, can be coupled or attached at the tube nozzle 24 to extend downward into the container and through which the beverage can flow when dispensed. The tube 25 can be coupled to the nozzle in any manner, such as by threaded screw, press-fir connector, friction-fit connector, or clamp connection, or the tube 25 can be fabricated as an integral extension of the tube nozzle 24. The tube 25 can be cylindrical, with a circular cross-section and uniform wall thickness, or can have any constant or varying cross-sectional area and/or shape and/or wall thickness.

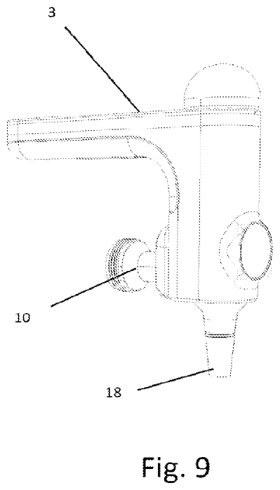

Referring to FIG. 9, the handle assembly 3 is configured to be attached to the tap valve assembly 10 to provide an ergonomic grasping surface for a user to facilitate manipulation of the tap valve assembly 10 when pouring a beverage. When the handle assembly 3 is moved into the pouring position, the tap valve assembly 10 opens the valve, allowing the beverage to flow up the tube 25, through the faucet 21, and out of the tap nozzle 18 under pressure of the gas in the gas canister. When the handle assembly 3 is moved into the closed position, the tap valve assembly 10 closes the valve, preventing the beverage from flowing through the faucet 21 and out of the tap nozzle 18, but keeping the beverage ready to be dispensed under pressure of the gas in the gas canister.

Thus, the beverage dispensing apparatus provides a brewed beverage under pressure. The apparatus can be made compact enough to be used on a kitchen countertop or otherwise arranged for home use, or on a larger scale can be used commercially. The apparatus can be used to dispense a brewed beverage such as coffee, and using nitrogen as the pressurizing gas can impart favorable qualities to the dispensed beverage. The apparatus is configured to couple with a container having a valved opening (or includes the container) that is otherwise sealed, so the contained beverage remains fresh until dispensed.

The invention has been described by way of example and in terms of preferred and exemplary embodiments. However, the invention as contemplated by the inventor is not strictly limited to the particularly disclosed embodiments. To the contrary, various modifications, as well as similar arrangements, are included within the spirit and scope of the invention. The scope of the appended claims, therefore, should be accorded the broadest reasonable interpretation so as to encompass all such modifications and similar arrangements.

I claim:

1. A tapper assembly for a beverage dispenser, comprising:
a container cap assembly;
a tap body assembly; and
a tap valve assembly;
wherein the container cap assembly includes:
an open container interface configured to couple with a container opening,
a canister interface, arranged in fluid communication with the open container interface, that is configured to couple with a gas canister and to receive pressured gas from the gas canister, and
a tap opening configured to couple with the tap body assembly;
wherein the tap body assembly includes:
a tube nozzle configured to couple with a tube to extend the tube from the open container interface when the tap body assembly is coupled with the tap opening of the container cap assembly,
a valve interface configured to couple the tap body assembly with the tap valve assembly, and
a faucet configured to provide fluid communication between the tube nozzle and the valve interface; and
wherein the tap valve assembly includes:
a tap nozzle configured to dispense a beverage from the tap valve assembly, and
a tap valve body configured to couple with the tap body assembly at the valve interface and to provide selective fluid communication between the valve interface and the tap nozzle.

2. The tapper assembly of claim 1, wherein the canister interface is configured to couple directly to the gas canister.

3. The tapper assembly of claim 1, wherein the canister interface is configured to couple with the gas canister via a hose.

4. The tapper assembly of claim 1, further comprising a gas canister sleeve configured to receive and hold the gas canister,
wherein the canister interface is configured to couple with the gas canister sleeve.

5. The tapper assembly of claim 4, further comprising the gas canister, configured to couple with the canister interface.

6. The tapper assembly of claim 5, wherein the gas canister contains compressed nitrogen.

7. The tapper assembly of claim 1, further comprising the gas canister, configured to couple with the canister interface.

8. The tapper assembly of claim 7, wherein the gas canister contains compressed nitrogen.

9. The tapper assembly of claim 1, wherein the open container interface includes a container coupler configured to couple with the container opening.

10. The tapper assembly of claim 1, wherein the canister interface includes a canister coupler configured to couple with the gas canister.

11. The tapper assembly of claim 10, further comprising the gas canister, configured to couple with the canister coupler.

12. The tapper assembly of claim 1, wherein at least one of the tap opening and the valve interface includes a tap coupler configured to couple the tap body assembly with the tap valve assembly.

13. The tapper assembly of claim 1, further comprising the tube, coupled with the tube nozzle.

14. A beverage dispenser, comprising:
the tapper assembly of claim 1; and
a container, configured to receive and hold a liquid, wherein the container includes the container opening.

15. The beverage dispenser of claim 14, wherein at least one of the container interface and the container opening includes a container coupler configured to couple the container interface with the container opening.

16. The beverage dispenser of claim 14, wherein the container opening is configured to receive the tube when the tube nozzle is coupled with the tube and the tap body assembly is coupled with the tap opening of the container cap assembly.

17. The beverage dispenser of claim 14, wherein the container opening is unobstructed.

18. The beverage dispenser of claim 17, wherein the container is configured to receive a liquid poured directly into the container opening.

19. The beverage dispenser of claim 14, wherein the liquid is a brewed beverage.

20. The beverage dispenser of claim 19, wherein the brewed beverage is coffee.
